(19) United States
(12) Patent Application Publication
(10) Pub. No.: US 2009/0194469 A1
(43) Pub. Date: Aug. 6, 2009

(54) SORTER SYSTEM WITH POCKET BRAKE

(75) Inventors: David P. Chastain, New Milford, CT (US); Brad A. Swinford, New Milford, CT (US); Allen L. Simers, Danbury, CT (US); David W. Purcell, New Milford, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/027,075

(22) Filed: Feb. 6, 2008

(51) Int. Cl. B07C 9/00

(52) U.S. Cl. 209/652

(57) ABSTRACT

A sorter system comprises a transport for advancing items along a transport path, a diverter for directing items from the transport path into a selected pocket along a sort path, and a pocket brake disposed in the selected pocket. In one embodiment, the pocket brake comprises a pivotable flange defining a pivot axis, at least one support element disposed on the flange, a braking element disposed on the at least one support element for decreasing a velocity of an item entering the selected pocket along the sort path, and a registration surface for stopping translation of the item along the sort path.

### FIELD OF THE INVENTION

The present invention relates to a sorter system and, more particularly, to a sorter system having a brake disposed in one or more of the sortation pockets.

### BACKGROUND OF THE INVENTION

Sorter systems generally comprise an intake portion in which mailpieces, for example, are fed into the system for processing. The mailpieces are fed along a transport and subsequently deposited in one of a number storage receptacles based on one or more sortation criteria. Some sorters utilize bins (e.g., tubs) for storing the sorted mailpieces, while others utilize pockets.

In some cases the pockets are used to maintain the sorted mailpieces in a predetermined order. In such systems hardware is provided to keep mailpieces arranged within the pocket. The hardware includes various plates arranged to stop the mailpieces entering the pockets and to hold them in a given orientation.

Operating speed is an important consideration in the design of sorter systems, as with most other mail-handling equipment. In such systems, mailpieces from the transport enter the pockets at a high velocity and are rapidly decelerated. In some devices, the mailpieces have been found to impact the plates in the pockets at velocities of up to 165 inches per second. The impact forces in those devices may damage or destroy sensitive mailpieces. Conventional sorter systems for processing sensitive mailpieces have been limited to processing speeds of 12,000 mailpieces per hour.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In accordance with the purpose of the invention, as embodied and broadly described herein, one aspect of the invention relates to a sorter system comprising a transport for advancing items along a transport path, a diverter for directing items from the transport path into a selected pocket along a sort path, and a pocket brake disposed in the selected pocket.

As used herein, “items” include papers, documents, postcards, envelopes, enclosures, and packages having a range of sizes and materials. In some embodiments, items comprise CDs, DVDs, computer disks, and/or other digital storage media. Items may comprise and/or be enclosed in materials ranging from those having a relatively high thickness and rigidity, such as cardboard, for example, to those having a relatively low thickness and rigidity, such as polymer wraps, for example.

In one embodiment, the pocket brake comprises a pivotable flange defining a pivot axis, at least one support element disposed on the flange, a braking element disposed on the at least one support element for decreasing a velocity of an item entering the selected pocket along the sort path, and a registration surface for stopping translation of the item along the sort path.

In another aspect, the invention relates to a sorter system, comprising a transport for advancing items along a transport path, a diverter for directing items from the transport path into a selected pocket along a sort path, and a pocket brake disposed in the selected pocket. In one embodiment, the pocket brake is pivotable between a receiving position and a pivoted position about a pivot axis.

In other embodiments, the pocket brake comprises at least one support element, a braking element disposed on the at least one support element for slidably contacting an item within the selected pocket to decrease a velocity of the item along the sort path, and a registration surface for contacting the item to stop translation of the item along the sort path. In some embodiments, the pocket brake converts the translation of the item into a rotation about the pivot axis.

In a further aspect, the invention provides a method of sorting items, comprising advancing items along a transport path, diverting items from the transport path into a selected pocket along a sort path, and receiving an item in the selected pocket using a pocket brake. In one embodiment, receiving an item comprises slidably contacting the item with a braking element to decrease a velocity of the item along the sort path, and contacting the item with a registration surface to stop translation of the item along the sort path.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate an exemplary embodiment of the invention and, together with the description, serve to explain the principles of the invention. In the drawings,

FIG. 1 is a schematic of an embodiment of a sorter system according to the present invention;

FIG. 2 is a perspective view of an embodiment of a sorter pocket according to the invention;

FIG. 3 is a perspective view of an embodiment of a pocket brake according to the invention; and

FIG. 4 is a plan view of the sorter pocket of FIG. 2.

### DETAILED DESCRIPTION OF EXEMPLARY EMBODIMENTS

Reference will now be made in detail to an exemplary embodiment of the invention, an example of which is illustrated in the accompanying drawings. Wherever possible, the same reference numbers will be used throughout the drawings to refer to the same or like parts.

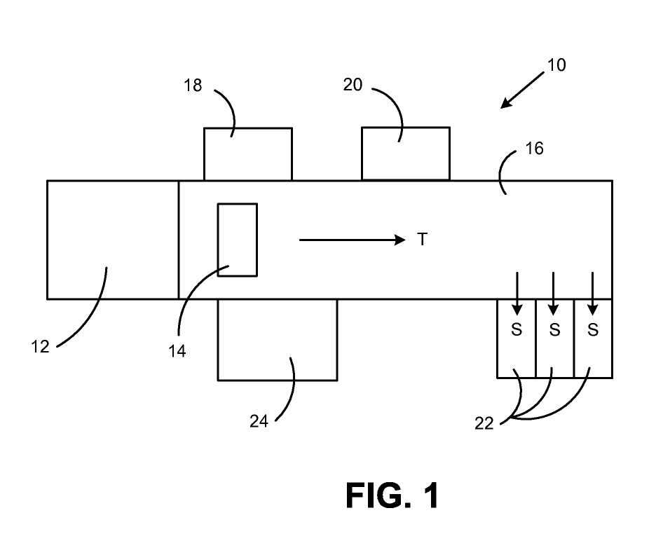

An embodiment of a sorter system 10 according to the present invention is shown in FIG. 1. As shown, the system 10 includes a feeder 12 for supporting items 14 as they are fed into the system 10 for processing. The feeder 12 moves each item 14 onto a transport 16, which advances the items 14 through the sorter system 10 along a transport path T.

In the illustrated embodiment, the system 10 also includes a scanner 18, such as an optical scanner, for example, to read information from each item 14 moving along the transport 16. The illustrated embodiment also includes a printer 20 for adding any desired print information to the items 14. After moving past the printer 20, each item 14 proceeds along the transport 16 until it is diverted from the transport path T into a selected pocket 22 along a sort path S.

The pockets 22 may be arranged in multi-level tiers (not shown) to increase the storage capacity of the system without increasing the floor space it occupies. Sorter systems including multi-level tiers may also include an elevator to move respective items from the transport to a desired tier.

A controller 24, such as a user interface computer, for example, is used to control the operation of the system 10. In one example, the controller 24 analyzes the information obtained by the scanner 18 from the face of the item 14. The controller 24 then activates the printer 20 to print corresponding information on the item 14, such as delivery information, for example. Finally, based on the scanned information, the controller 24 causes the item 14 to be diverted to a selected pocket 22. The selected pocket 22 may include items directed to a common ZIP code, address, or mail stop, for example.

In some applications the sorter system may be used for “in-sorting,” e.g., sorting items arriving in an organization. In those applications, the internal mail stops may be printed on the items and the items may be sorted based on those mail stops, for example. In other applications the sorter system may be used for “out-sorting,” e.g., sorting items for delivery to a postal carrier, for example. In those applications, destination address information, such as a bar code, may be printed on the items and the items may be sorted based on the destination address, for example.

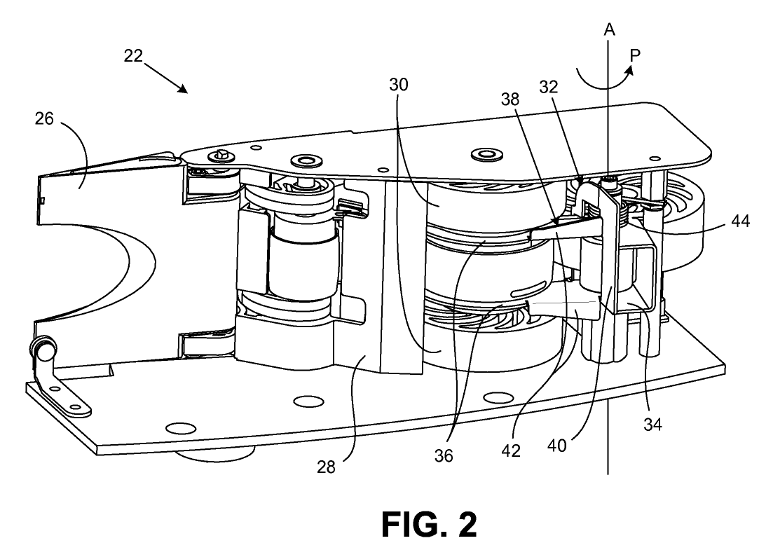

An embodiment of a pocket 22 according to the invention is shown in FIG. 2. When activated by the controller 24, a diverter 26 associated with the pocket 22 is moved into the transport path T to direct items 14 from the transport path T into the selected pocket 22 along a sort path S. The momentum of the item 14 moving along the transport 16 carries the item 14 into the pocket 22, where the item encounters a guide 28.

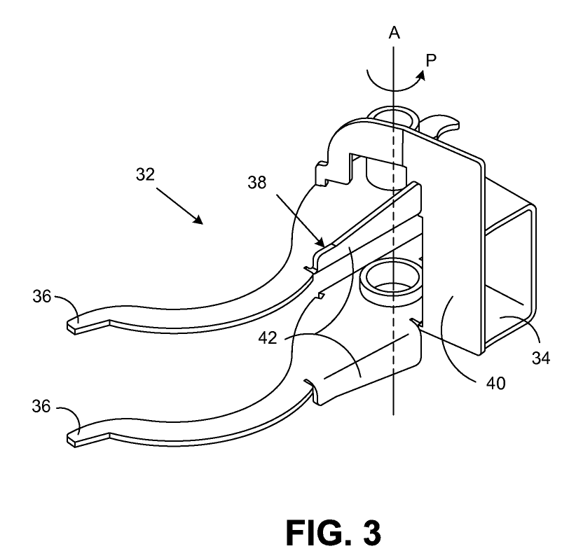

As the item 14 moves past the guide 28, a leading edge of the item 14 encounters drive rollers 30 that activate to positively control the item 14 as it moves farther into the pocket 22. As the item 14 moves past the drive rollers 30, it encounters a pocket brake 32 disposed in the selected pocket 22. An embodiment of the pocket brake 32 is shown in detail in FIG. 3.

As shown in FIG. 3, the pocket brake 32 comprises a pivotable flange 34 defining a pivot axis A, at least one support element 36 disposed on the flange 34, and a braking element 38 disposed on the at least one support element 36. In the illustrated embodiment, the pocket brake 32 comprises two support elements 36. Other numbers of support elements 36 may also be used. The pocket brake 32 further comprises a registration surface 40 for stopping translation of the item 14 along the sort path S.

The braking element 38 interacts with the item 14 entering the selected pocket 22 to decrease a velocity of the item 14 along the sort path S. In the illustrated embodiment, the braking element 38 comprises a friction plate 42 disposed on each support element 36. In operation, the friction plates 42 slidably contact the item 14 to decrease the velocity of the item 14. Thus, the friction plates 42 slow the velocity of the item 14 prior to the item 14 contacting the registration surface 40. In the embodiment shown in FIGS. 2 and 3, the registration surface 40 is disposed on the pivotable flange 34 between the diverter 26 and the pivot axis A.

In the illustrated embodiment, the pocket brake 32 is pivotable about the pivot axis A between a receiving position and a pivoted position, as indicated by arrow P, and is biased to the receiving position by a torsion spring 44. Other biasing mechanisms may also be used.

In operation, an item 14 enters the pocket 22, slows down upon sliding contact with the friction plates 42, then contacts the registration surface 40. The registration surface 40 stops translation of the item 14 along the sort path S. The contact between the item 14 and the registration surface 40 causes the pocket brake 32 to pivot from the receiving position to the pivoted position. When the pocket brake 32 pivots to the pivoted position, the support elements 36 deflect the item 14 substantially perpendicularly to the sort path S. Thus, the pocket brake 32 converts the translation of the item 14 along the sort path S into a rotation about the pivot axis A. After pivoting to the pivoted position, the pocket brake 32 returns to the receiving position under the biasing force of the spring 44.

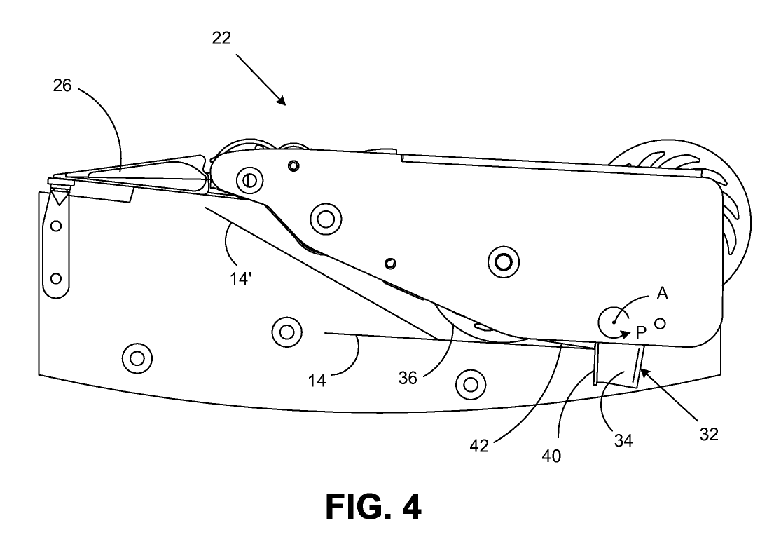

Once an item 14 is disposed in the pocket 22, subsequent items 14′ may be added to the pocket 22, as shown in FIG. 4. As subsequent items 14′ are added, the braking element 38 and a preceding item 14 in the selected pocket 22 interact with a subsequent item 14′ entering the selected pocket 22 to decrease a velocity of the subsequent item 14′. Thus, for subsequent items 14′, there is sliding contact with the braking element 38 on one side and with the preceding mailpiece 14 on the other side.

In some applications it is desirable to maintain the items in the pocket in the order in which they were added to the pocket. In the pocket 22 according to the invention, the leading edge of each subsequent item 14′ entering the pocket 22 is guided by the trailing edge of a preceding item 14 that is already in the pocket 22, as shown in FIG. 4. More specifically, the leading edge of each subsequent item 14′ is deflected by the trailing edge of a preceding item 14 and guided into the space between the preceding item 14 and the pocket brake 32. The position of the trailing edge is determined by the location of the registration surface 40 and the length of the item 14.

In one application, the pocket brake according to the invention may be used to decrease the velocity of items that have impact sensitivity as those items are diverted to pockets in a sorter system. In one example, embodiments of the pocket brake may be used to decrease the velocity of media items, such as CDs, DVDs, computer disks, and/or other digital storage media. Such media items may sustain damage, such as chipping and splitting, for example, from high-speed processing in sorter systems and, in particular, from impacting a stop in a sortation pocket at high speed.

Sorter systems utilizing embodiments of the invention have obtained processing speeds of 45,000 items per hour, while reducing impact velocities to protect sensitive items, such as media items.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A sorter system, comprising:
a transport for advancing items along a transport path;
a diverter for directing items from the transport path into a selected pocket along a sort path; and
a pocket brake disposed in the selected pocket, comprising:
a pivotable flange defining a pivot axis;
at least one support element disposed on the flange;
a braking element disposed on the at least one support element for decreasing a velocity of an item entering the selected pocket along the sort path; and
a registration surface for stopping translation of the item along the sort path.

2. The system of claim 1, wherein the at least one support element comprises a plurality of support elements.

3. The system of claim 2, wherein the braking element comprises a friction plate disposed on each support element.

4. The system of claim 1, wherein the braking element slidably contacts the item to decrease the velocity of the item.

5. The system of claim 1, wherein the braking element and a preceding item in the selected pocket decrease a velocity of a subsequent item entering the selected pocket.

6. The system of claim 1, wherein the registration surface is disposed on the pivotable flange.

7. The system of claim 1, wherein the registration surface is disposed between the diverter and the pivot axis.

8. The system of claim 1, wherein the pocket brake converts the translation of the item along the sort path into a rotation about the pivot axis.

9. The system of claim 1, wherein the pocket brake is pivotable about the pivot axis between a receiving position and a pivoted position in which the support element deflects the item substantially perpendicularly to the sort path.

10. The system of claim 9, wherein the pocket brake is biased to the receiving position.

11. A sorter system, comprising:
a transport for advancing items along a transport path;
a diverter for directing items from the transport path into a selected pocket along a sort path; and
a pocket brake disposed in the selected pocket, wherein the pocket brake is pivotable between a receiving position and a pivoted position about a pivot axis, the pocket brake comprising:
at least one support element;
a braking element disposed on the at least one support element for slidably contacting an item within the selected pocket to decrease a velocity of the item along the sort path; and
a registration surface for contacting the item to stop translation of the item along the sort path, wherein the pocket brake converts the translation of the item into a rotation about the pivot axis.

12. The system of claim 11, wherein the at least one support element comprises a plurality of support elements.

13. The system of claim 12, wherein the braking element comprises a friction plate disposed on each support element.

14. The system of claim 11, wherein the braking element and a preceding item in the selected pocket slidably contact a subsequent item entering the selected pocket to decrease a velocity of the subsequent item.

15. The system of claim 11, wherein the registration surface is disposed between the diverter and the pivot axis.

16. The system of claim 11, wherein the pocket brake is biased to the receiving position.

17. The system of claim 11, wherein the at least one support element deflects the item in the selected pocket substantially perpendicularly to the sort path as the pocket brake moves to the pivoted position.

18. A method of sorting items, comprising:
advancing items along a transport path;
diverting items from the transport path into a selected pocket along a sort path; and
receiving an item in the selected pocket using a pocket brake, wherein receiving an item comprises:
slidably contacting the item with a braking element to decrease a velocity of the item along the sort path; and
contacting the item with a registration surface to stop translation of the item along the sort path.

19. The method of claim 18, further comprising converting the translation of the item along the sort path into a rotation about a pivot axis of the pocket brake.

20. The method of claim 18, wherein the pocket brake is pivotable from a receiving position to a pivoted position.

21. The method of claim 18, wherein the pocket brake is biased to the receiving position.
